(19) United States
(12) Patent Application Publication
(10) Pub. No.: US 2004/0031359 A1
(43) Pub. Date: Feb. 19, 2004

(54) Ratchetable wrench

(76) Inventor: Darren Kady, Glen Allen, VA (US)

Correspondence Address: Robert E.Bushnell, Suite 300, 1522 K Street, N.W., Washington, DC, 20005-1202, US

(21) Appl. No.: 10/637,702

(22) Filed: Aug. 11, 2003

Related U.S. Application Data
(60) Provisional application No. 60/402,146, filed on Aug. 9, 2002.

(51) Int. Cl. B25B 13/12

(52) U.S. Cl. 81/179

(57) ABSTRACT

A hand tool may be constructed with one or more longitudinally reciprocating serrated inserts held by a pair of oppositely facing jaws forming an arc, with a first of the jaws defining an arcuate greater section of the arc and containing a first passage opening into the arc to expose a plurality of lands separated by intervening teeth of a movable ratcheting element, and a second of the jaws containing an arcuate lesser section of the arc and being perforated by a second passage opening into said arc to expose a plurality of lands separated by intervening teeth of an opposing ratcheting element, in a plurality of cooperating alignments with the lands and teeth of the movable element. The two ratcheting elements are disposed with the arc between the jaws to directly engage, in cooperation with individual lands of said opposing element, diametrically opposite features of a rotatable element, in a succession of grasps equally amenable to both non-ratchetable and ratchetable movement of said hand tool relative to the rotatable element.

### CLAIM FOR PRIORITY

This application makes reference to, incorporates the same herein, and claims all right accruing from our earlier filing of a provisional patent application entitled RATCHETABLE WRENCH filed in the United States Patent & Trademark Office on Aug. 9, 2002 and there assigned Serial No. 60/402,146.

### BACKGROUND OF THE INVENTION

1. Technical Field

This invention relates generally to hand tool and to processes for manufacturing hand tools, and more particularly, to ratchet wrenches, to processes of using ratcheting wrenches, and to processes for manufacturing ratcheting wrenches.

2. Related Art

Efforts have been made recently to develop open end and adjustable ratchet wrenches. The following patents each discloses features in common with the present application, but do not teach or suggest the specifically recited in the subject matter disclosed in the present invention: Chinese Patent Application No. 92105567.6 to Mu Qunfang, entitled WEDGE TYPE SPANNER, published on Feb. 24, 1993, U.S. Pat. No. 6,223,630 to Stanton, entitled OPEN END RATCHET WRENCH, issued on May 1, 2001, U.S. Pat. No. 6,202,516 to Kim, entitled UNIVERSAL SELF-ADJUSTING WRENCH, issued on Mar. 20, 2001, U.S. Pat. No. 5,996,445 to Wiens et al., entitled RATCHETING WRENCH, issued on Dec. 7, 1999, U.S. Pat. No. 5,768,958 to Gamble, entitled OPEN ENDED RACHET WRENCH, issued on Jun. 23, 1998, U.S. Pat. No. 5,595,098 to Malkin et al., entitled TOOL HAVING JAWS FOR GRIPPING HEXAGONALLY SHAPED OBJECTS, issued on Jan. 21, 1997, U.S. Pat. No. 5,582,082 to Gajo, entitled OPEN-END WRENCH HAVING SELF-CONTAINED RATCHETING MECHANISM ALLOWING ONE-WAY ROTATIONAL DRIVING OF A HARDWARE ELEMENT, issued on Dec. 10, 1996, U.S. Pat. No. 5,533,428 to Pradelski, entitled RATCHETABLE OPEN-ENDED WRENCH, issued on Jul. 9, 1996, U.S. Pat. No. 4,440,047 to Robbins, entitled UNI-DIRECTIONAL DRIVE WRENCH, issued Apr. 3, 1984, U.S. Pat. No. 4,255,990 to Doan, entitled RATCHET-ACTION END WRENCH WITHOUT RATCHET, issued on Mar. 17, 1981, U.S. Pat. No. 2,879,681 to Blasdell, entitled SLIDABLE JAW-FACE, OPEN-END WRENCH, issued on Mar. 31 1959, U.S. Pat. No. 1,369,459 to Miskimen, entitled WRENCH, issued on Feb. 22, 1921, and U.S. Pat. No. 1,308,440 to Morrison, entitled WRENCH, issued on Jul. 1, 1919.

I have noticed that some of these designs are incapable of providing a small degree of ratchet, that is, a single counter-turn of less than approximately forty-five degrees of arc, thereby rendering the wrench cumbersome, or useless, in confined spaces.

I have also noticed that a common problem attendant to the manufacture and use of wrenches described in these exemplars of the art, particularly that taught by Mu Qunfang '567.6 patent application, is the all too frequent binding and accompanying hindrance of free movement of the ratcheting elements to bind during the counter-turn of the wrench; consequently, in lieu of a ratcheting of the jaws of the wrench against a movable or rotatable element such as one component of a threaded fastener (e.g., the head of a bolt, or against a nut threaded onto a bolt or stud), the jaws maintain a fixed grasp of the head, or nut, with a concomitant undesired loosening, or alternatively, tightening, of the threaded fastener during the counter-turn. I have discovered that these designs fail to imbue their wrenches with an essential modicum of correspondence and alignment between the numerous aspects of the wrench engaging the threaded member.

### SUMMARY OF THE INVENTION

Accordingly, it is one object of the present invention to provide an improved ratchet wrench, process for manufacturing ratchet wrenches, and process for using ratchet wrenches.

It is another object to provide a ratchet wrench, process for manufacturing ratchet wrenches, and process for using ratchet wrenches, endowed with a symmetrical alignment between the features of the jaws of the wrench and the fastener grasped by the jaws.

It is still another object to provide a ratchet wrench, process for manufacturing ratchet wrenches, and process for using ratchet wrenches, with the stationary aspects of the jaws of the wrench permitting a continuous freedom of relative movement between movable elements borne by the jaws and the fastener grasped by those elements.

It is yet another object to provide a ratchet wrench, process for manufacturing ratchet wrenches, and process for using ratchet wrenches, exhibiting jaws that are able to hold a rotatable component in both a non-ratcheting grasp and in a ratcheting grasp.

It is still yet another object to provide ratchet wrench, process for manufacturing ratchet wrenches, and process for using ratchet wrenches enabling a finer degree of ratcheting.

It is a further object to provide a ratchet wrench, process for manufacturing ratchet wrenches, and process for using ratchet wrenches, endowed with an improved configuration and orientation of the jaws of the wrench.

It is another object to provide a ratchet wrench, process for manufacturing ratchet wrenches, and process for using ratchet wrenches to hold a rotatable work piece in a succession of incrementally different alignments, with a plurality of those alignments providing both non-ratcheting and ratcheting grasps of the workpiece by the wrench.

These and other objects may be attained with a tool, such as a wrench, having oppositely facing jaws defining an arc, with at least one of those jaws bearing a freely movable serrated element facing a correspondingly serrated element borne by the opposing jaw. Each of the serrated elements has a distal portion that exhibits a plurality of lands which are separated by an array of intermediate teeth disposed within the arc by their respective jaws. The most distal lands of each serrated element are continuously exposed by its respective jaws to enable diametrically opposite corners of a moveable workpiece to reciprocatingly displace at least the moveable serrated element and permit the moveable workpiece to sequently slide into a plurality of selectively ratcheting and non-ratcheting grasps with a succession of the lands as the individual lands of the distal end of the serrated, reciprocating element are successively exposed by their respective jaws to sequently directly engage, in cooperation with the diametrically opposite land of the serrated element borne by the opposing jaw, diametrically opposite features of a rotatable element, either in a non-ratchetable, or in a ratchetable, grasp.

### BRIEF DESCRIPTION OF THE FIGURES

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a fragmentary perspective view of an open-end wrench constructed in accordance with the principles of the present invention;

FIG. 2 is an exploded fragmentary view, shown partlyin cross section, of an open-end wrench constructed in accordance with the principles of the present invention;

FIG. 3 is a view of the embodiment of FIG. 2 shown, in assembled form;

FIG. 4 is a fragmentary view, shown partly in cross section, of an adjustable wrench constructed in accordance with the principles of the present invention;

FIG. 5 is a fragmentary view, shown partly in cross section, of an adjustable wrench illustrated as an alternate embodiment of a toothed ratchet having a flat end region;

FIG. 5a is a view of a toothed ratchet element constructed with a flat end region;

FIG. 6 is a fragmentary view, shown partly in cross section, of the adjustable wrench of FIG. 5 shown with a small nut, or bolt head, gripped by the wrench;

FIG. 7 is a fragmentary view, shown partly in cross section, of the adjustable wrench of FIG. 6, shown with a larger nut, or bolt head, gripped by the wrench, that is in contract with a toothed ratchet element having a flat end region;

FIG. 8 is a fragmentary view, shown partly in cross section, of an alternate embodiment of an adjustable wrench having a toothed ratchet mechanism;

FIG. 9 is a fragmentary view, shown partly in cross section, of the adjustable wrench of FIG. 8, shown with a large nut, or bolt head, gripped by the wrench, that is in contact with a toothed ratchet element having a flat end region;

FIG. 10 is a fragmentary, partly exploded view, partly in cross section, of an adjustable wrench, shown with the limiting screw removed;

FIG. 11 is a fragmentary, partly exploded view, partly in cross section, of the adjustable wrench of FIG. 10, shown with an alternate embodiment of a limiting screw removed from its seated position.

FIG. 12 is a fragmentary view, of an adjustable wrench illustrated with an alternate embodiment of a gripping jaw, to show a toothed ratchet having a flat end region engaging a large nut, or bolt;

FIG. 13 is a fragmentary perspective view, shown partly in cross section, of the adjustable wrench of FIG. 12 with a smaller nut, or bolt head, gripped by the wrench, in contact with a toothed ratchet element having a flat end region;

FIGS. 14a through 14d are schematic illustrations of the relative positions of a nut and jaws of an adjustable wrench, sequentially illustrating progressive positions as the ratchet mechanism permits the nut to rotate in one direction relative to the wrench;

FIG. 15 is a schematic illustration of a further embodiment of an adjustable wrench of the present invention;

FIG. 16 is a schematic illustration of a still further embodiment of an adjustable wrench of the present invention;

FIG. 17 is a schematic illustration of an adjustable wrench, shown with a nut within the gripping jaws and illustrates non-curved contact points that can prevent the relative movement of the nut or bolt and wrench during an attempted ratcheting step;

FIG. 18 is a fragmentary perspective view of a still further alternate embodiment of a wrench and ratchet system of the present invention;

FIG. 19 is a fragmentary cross-sectional illustration of a seating mechanism for a screw portion of a ratchet mechanism of the present invention;

FIG. 20 is a fragmentary cross-sectional illustration of an alternate seating mechanism for a screw portion of a ratchet mechanism of the present invention;

FIG. 21 is a fragmentary cross-sectional illustration of a further alternate seating mechanism for a screw portion of a ratchet mechanism of the present invention;

FIG. 22 is a fragmentary cross-sectional illustration of the seating mechanism of FIG. 20, shown with the toothed element in an extended position;

FIG. 23 is a partial plan view of an adjustable jaw wrench constructed according to the principles of the present invention;

FIG. 24 is a fragmentary, cross-sectional illustration showing the seating of the ratcheting elements in the jaws of the adjustable wrench illustrated in FIG. 32;

FIG. 25 illustrates the details for the reciprocating seating of a ratcheting element in the stationary jaw of an adjustable wrench;

FIG. 26 illustrates an alternative configuration for the seating of a reciprocating ratcheting element within a passage of a stationary jaw of an adjusting wrench;

FIG. 27 is a partially cut-away cross-sectional view illustrating the seating of the ratcheting elements in an alternative embodiment of the present invention;

FIG. 28 is an exploded, cross-sectional view illustrating the details of FIG. 27;

FIG. 29 is a cross-sectional view illustrating the details of an alternative embodiment of the present invention;

FIG. 30 is a partially exploded, cross-sectional view illustrating the details of construction of an alternative embodiment of an open end wrench;

FIG. 31 is a plan, operational view showing the jaws in a first of a sequence of successive ratcheting orientations;

FIG. 32 is a plan, operational view showing the jaws in a second of a sequence of successive ratcheting orientations;

FIG. 33 a plan, operational view showing the jaws in a third of a sequence of successive ratcheting orientations; and

FIG. 34 is a fragmentary, projection view illustrating the details of construction of an alternative embodiment of an open end wrench constructed according to the principles of the present invention.

### DETAILED DESCRIPTION OF EMBODIMENTS OF THE INVENTION

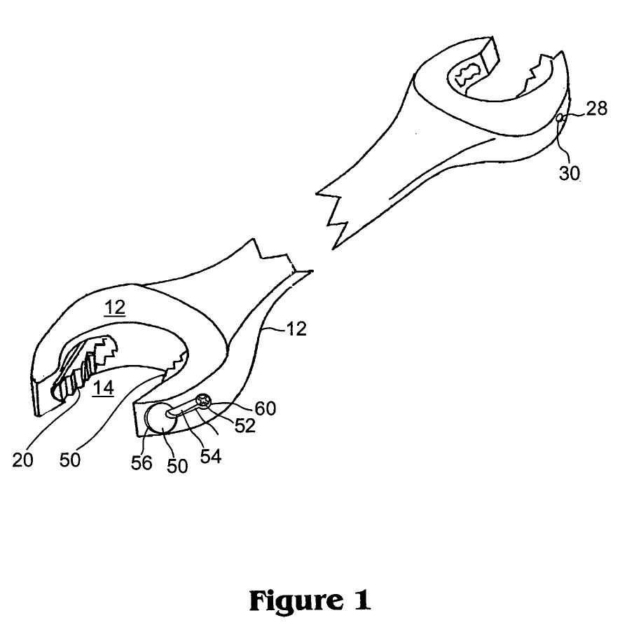

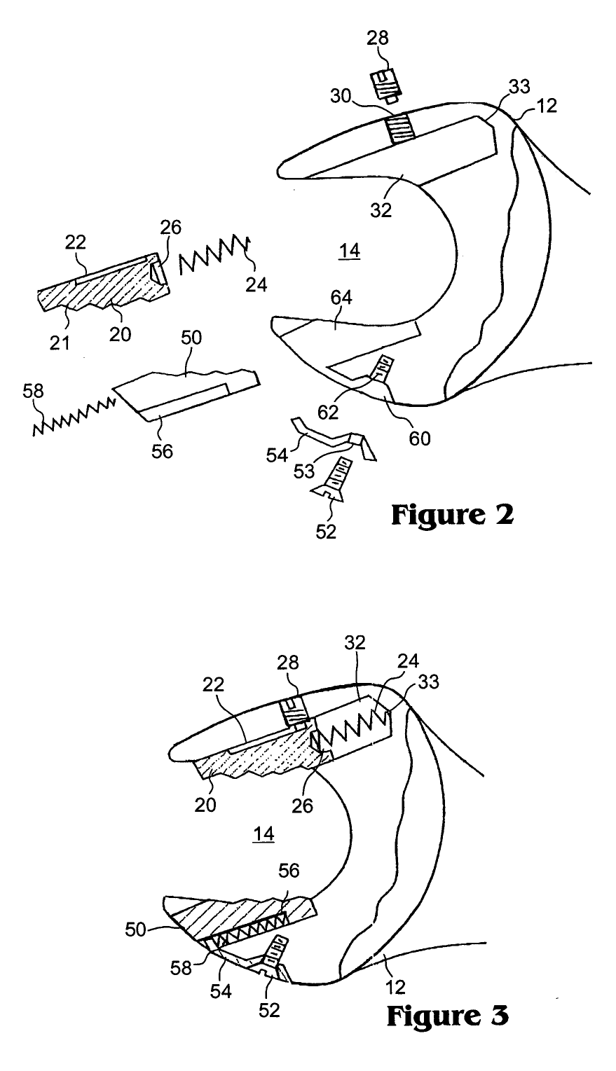

The disclosed invention incorporated into an open-ended wrench 10 is illustrated in FIG. 1. Although only the proximal end 12 of the wrench 10 is illustrated in detail, it should be noted that both ends can be the same, or one end may be constructed with the ratachable elements disclosed and one end may be constructed as a standard wrench. As can be seen clearly in FIGS. 2 and 3, when viewed in combination with FIG. 1, the interior distal end 12 is provided with a retracting tunnel 32 and an extending channel 64. Retracting tunnel 32 is open at one end to wrench arc 14 and closed at its opposite end 33 in a V-shaped configuration to facilitate maintenance of spring 24 in a centered position. Retracting channel 32 is dimensioned to receive spring 24 and toothed retracting element 20. Retracting element 20 has multiple teeth 21 spaced-apart, in succession along one side and a spring receiving recess 26. The opposite side of retracting element 20 contains an open channel 22 that is recessed by a slight distance into the width of retracting element 20 and that is dimensioned to receive the terminal end of set pin 28. Set screw 28 extends from the exterior side of the jaw of wrench 12 to retracting tunnel 32 and is positioned to slide within open channel 22.

The opposing side of the jaw of the head 12 of wrench 10 contains an extending tunnel 64 within the interior of the wrench that extends from the exterior side of the jaw through to wrench arc 14. Extending tunnel 64 has a stop channel 60 and a screw receiving hold 62. Extending element 50 has a spring channel 56 that is open to the end of the element 50 and dimensioned to receive the axial length of spring 58. Stop 54 is configured to fit into stop channel 60 and has a receiving through hole 53 to receive the passage of screw 52.

When assembled, as illustrated in FIG. 3, spring 24 is placed in retracting tunnel 32 followed by retracting element 20. Spring 32 is positioned with one terminal end in the V-shape terminus 33 of tunnel 32 and its axially opposite terminal end in receiving recess 26. Retracting element 20 is maintained in position through use of a set screw 28, the end of set screw 28 slides within open channel 22. During use, retracting element 20 retracts into the retracting tunnel 32 under pressure and is returned to its position by the force of compression from spring 24.

Extending element 50 is placed into extending tunnel 64 with spring 58 resting in spring channel 56. Stop 54 is then secured into position to maintain spring 58 within spring channel 56. When pressure is applied, extending element 50 axially compresses spring 58 and extends out, beyond the plane of head 12 of wrench 10. The pressure of the spring 58 returns the element 50 to its resting position when not in use.

It should be noted that the pins and screws illustrated herein can be of any configuration that will meet the required criteria as described herein. Additionally, although the heads of open-ended wrenches are generally rounded, it is important, as will be described further hereinafter, for the interior portion of the wrenches to be either rounded or recessed sufficiently to prevent interference with the removal of the nuts.

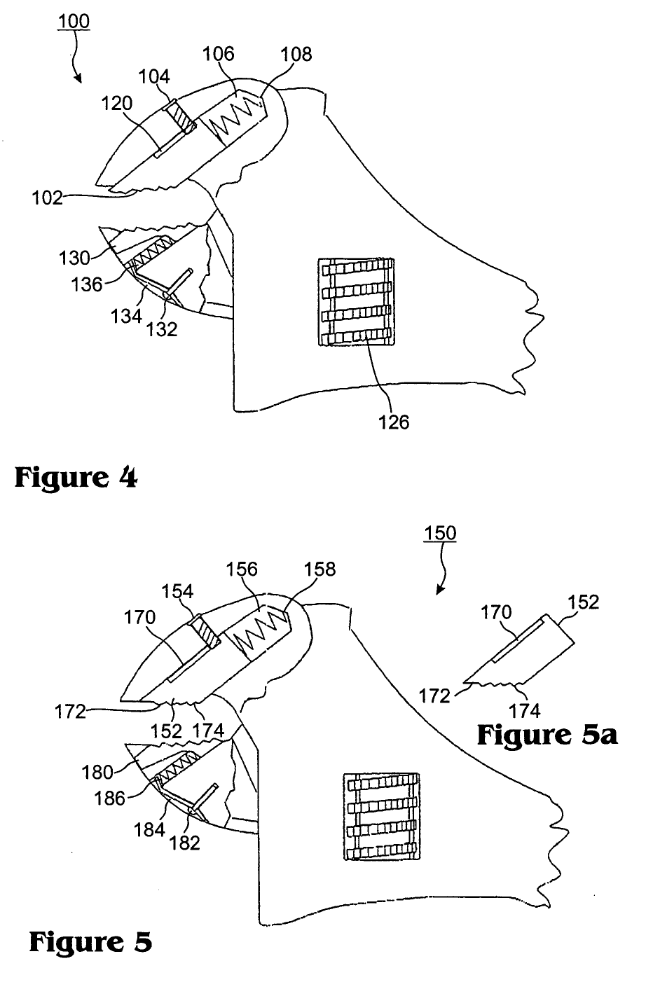

FIG. 4 illustrates an embodiment of a wrench indicated generally as 100. It employs a screw 104, having a head such that permits screw 104 to be threaded into its threaded receiving bore 110. Screw 104 limits the travel of toothed ratchet element 102. Elongated slot 120 receives the end of the screw 104. The interaction between screw 104 and ratchet element 102 is described in greater detail in the following discussion of FIGS. 21 and 22. Ratchet element 102 travels within bore 106 and is biased by spring bias to a longitudinally outward extended position.

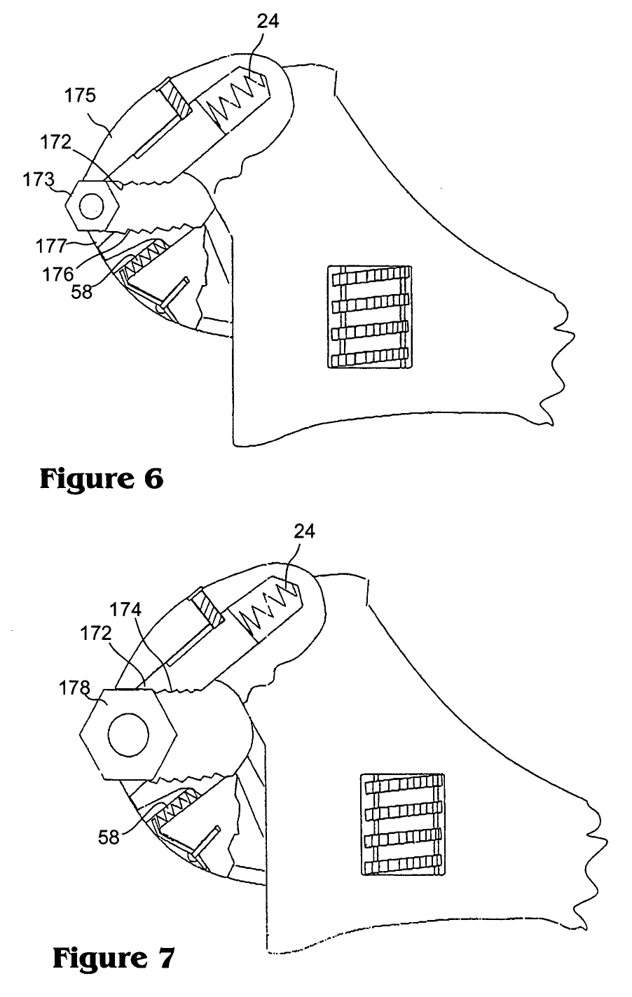

Similarly, second ratchet element 130 is spring biased to a longitudinally inwardly extended position by the force of spring 136. In each case the ratchet elements are spring biased to move toward the opposite sides of the nut, as may be best seen in FIGS. 6 and 7. During the ratcheting action, ratcheting elements 102, 130 are forced to move against the resistance of their corresponding springs 24, 58, thus permitting rotation of a nut or bolt relative to the wrench. The rotation is restricted from occurring in one direction and permitted in the opposite rotational direction. In this manner, the nut can be tightened or loosened without removing the wrench from contact with the head of the bolt or nut.

Retainer element 134 holds spring 136 in the bore. Thus, spring 136 is compressed between ratchet element 130 and retainer 134. Screw 132 holds retainer 134 in place. The jaws of the wrench are separated or brought closer together, as for example, through the user of a threaded rotating element 126.

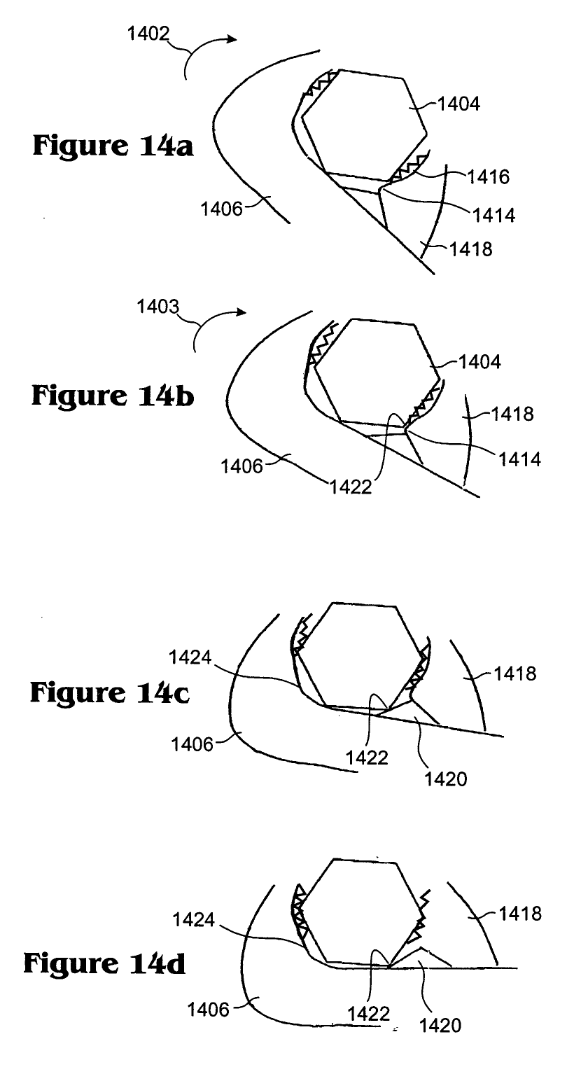

FIG. 5 illustrates an alternate embodiment of a wrench indicated generally as 150. Wrench has a toothed ratchet 152 having a flat entry port end region 122. Ratchet element 152 is spring biased to the extended position by spring 158 that travels within bore 156. The movement of ratchet element 152 is regulated by the interaction of screw 154 and the slot, or groove, 170, as described in greater detail in relation to FIGS. 21 and 22. The teeth 174 engage the apices of the head of the nut or bolt during the ratcheting action as illustrated in FIGS. 14a through 14d. The ratchet element 180, the spring 186, the retainer 184, and the screw 182 function as previously described in relation to FIG. 4.

FIG. 5a is a plan view of toothed ratchet element 152 having a flat end region 172. The flat end region permits the extreme ends of the jaws to grip the head of a nut, or bolt, without engaging the ratcheting elements.

FIG. 6 shows a small nut, or bolt head, 173 gripped by the wrench's jaw end regions 175 and 177.

FIG. 7 shows the adjustable wrench of FIGS. 5 and 6 with a larger nut, or bolt head, 178 gripped by the wrench's jaw end regions, in contact with the toothed ratchet element 174 adjacent to flat end region 172. In this application, when the nut is not seated between the ratchet jaws, the wrench does not permit a ratcheting action. The ratcheting action is best seen in the successive incremental movements between the bolt head and the ratchet elements illustrated by FIGS. 14a through 14d.

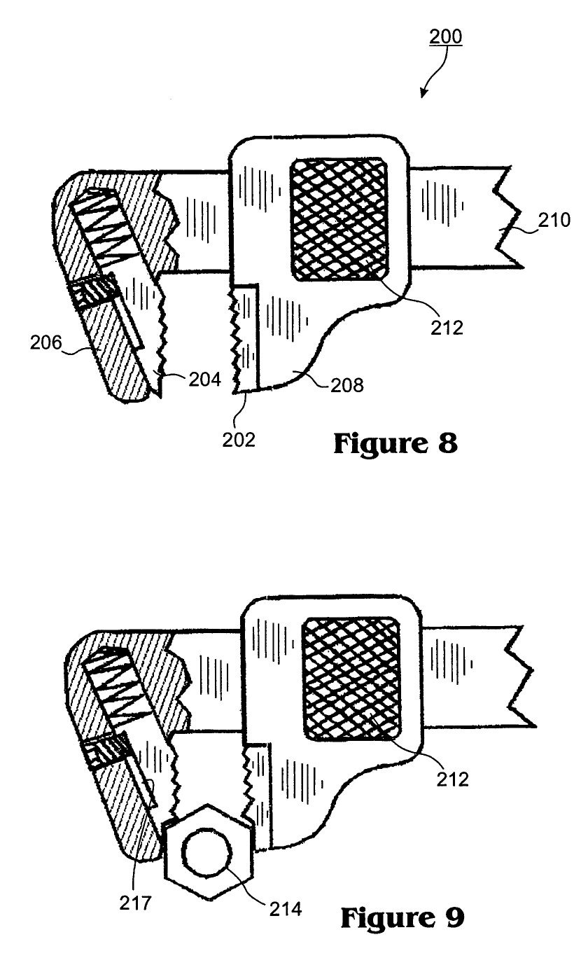

FIG. 8 is a fragmentary view, shown partly in cross section, of an alternate embodiment of an adjustable wrench indicated generally as 200, that has a toothed ratchet mechanism. Tooth elements 202, 204 function as illustrated in FIGS. 14a through 14d. The jaw 206 of wrench 200 is stationary relative to the handle 210, whereas the jaw 208 is relatively movable, as well known in the art. Movement is produced by rotating the knurled, threaded element 212.

FIG. 9 illustrates a variation of the adjustable wrench of FIG. 8. As shown, a large bolt head 214 is gripped by jaws 206, 208 of wrench 200. Nut 214 is in contact with and locked between the toothed ratchet element 206 having a flat terminal region 218 and the toothed ratchet element 202 having a flat terminal region 219. In this application, when the nut is not seated into the ratchet jaws, the wrench does not provide a ratcheting action.

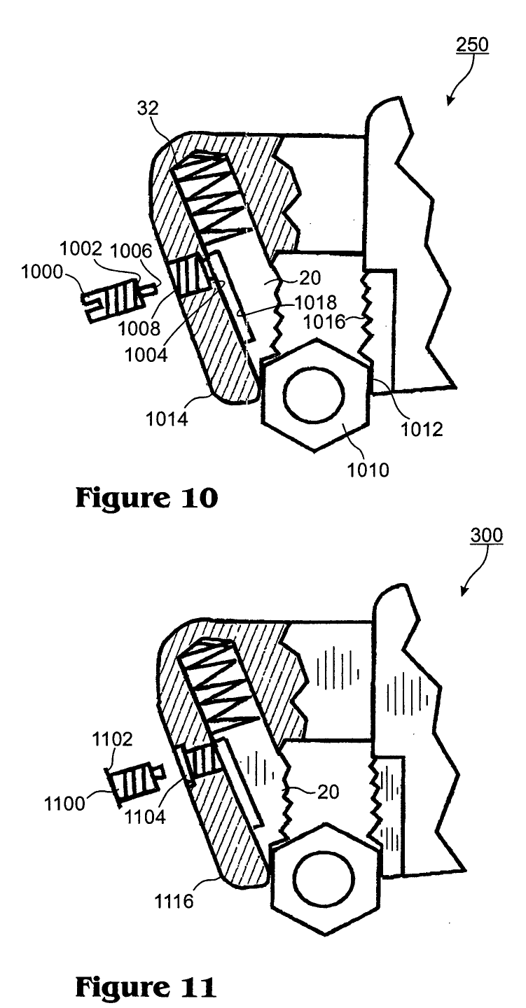

FIG. 10 is a fragmentary, exploded view, shown partly in cross section, of an adjustable wrench indicated generally as 250, shown with the limiting screw 1000 removed from the fixed jaw 1016. Limiting screw 1000 prevents retracting ratchet element 20 from sliding longitudinally out from retracting tunnel 32. The based end 1002 of the screw 1000 seats against the ledge 1004 of the screw receiving bore. In this manner, the screw can be tightened to a predetermined maximum position and thus firmly locked in place. Nut 1010 is shown gripped between the flat terminal portion 1016 of ratchet element 20 and the flat terminal end 1012 of stationary element 1018.

FIG. 11 is a fragmentary view, partially exploded view, shown partly in cross section, of an adjustable wrench indicated generally as 300, of the type shown in FIG. 10, indicated generally as 250. FIG. 11 shows an alternate embodiment of a limiting screw 1100 removed from its seated position within jaw 1116. Screw 1100 has a head 1102 that seats against the ledge 1104 inside of the bore 1006 in the jaw 1116. This mechanism limits the extent to which limiting screw 1100 can be threaded into the jaw, and may incorporated into any of the designs disclosed herein, such as shown in the various embodiments illustrated by FIGS. 1 through 10 and FIGS. 12 through 20, or through other functionally similar designs. The absence of this feature permits the deleterious insertion of limiting screw 1000 to the maximum depth of bore 1018, in the design illustrated by FIG. 10; consequently, direct, physically engagement of the end of tip 1006 against the wall 1018 of open channel 32 will cause ratcheting element 32 to bind against tip 1006, and will deleteriously hinder the ratcheting function of wrench 250. This maximum insertion of a screw into its bore, will concomitantly cause the screw to be over-seated and apply too much pressure to the ratchet member, thus restricting the smooth reciprocating action of the ratchet member 32. Insufficient tightening leaves the screw free to migrate out of its seated position due to vibration and the like, attributable to normal use of the tool.

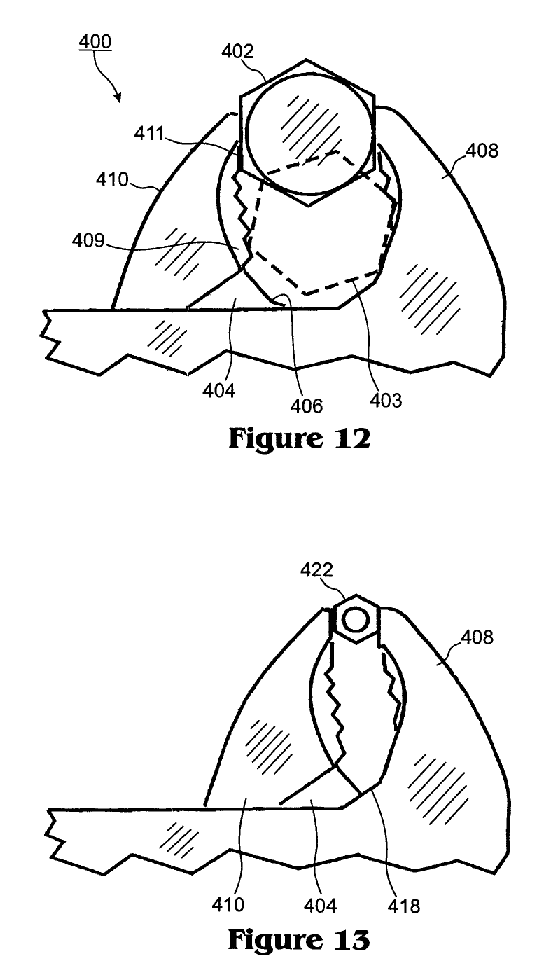

FIG. 12 is a fragmentary view of an adjustable wrench indicated generally as 400. Wrench 400 is an alternate embodiment of gripping jaws 408 and 410 designed to provide toothed ratchet element 409 having a flat end region 411 engaging the land of a large nut, or the head of a bolt 402. An alternate nut engaging position is illustrated by the phantom nut 403 seated in the ratcheting position. The reduced thickness region 404 of the web of jaw 410 is shown with a gradual ramp region 406, to facilitate the movement of the nut 403 during rotation with respect to the wrench 400.

FIG. 13 shows the adjustable wrench of FIG. 12, with a smaller nut or bolt head 422 gripped by the wrench and in contact with the toothed ratchet element 409 having a flat end region 411. The region 404 is shown recessed into the ramp region 418 of the jaw 408. The gradual ramp region 418 facilitates the movement of a nut during rotation with respect to the wrench 400 provides a ratcheting action.

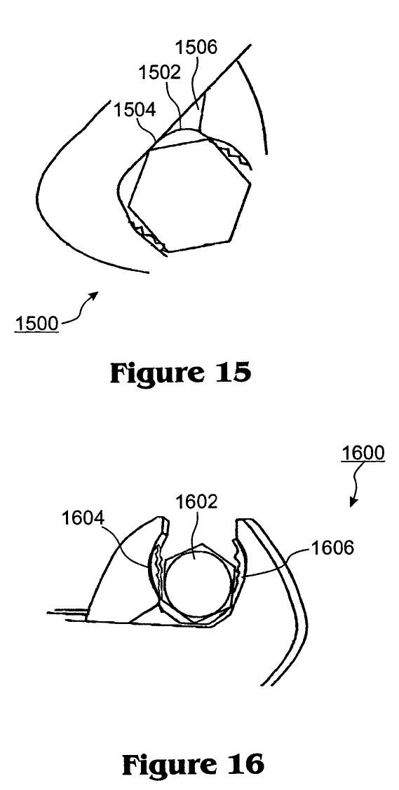

FIGS. 14a through 14d are schematic illustrations of the relative positions of a nut 1404 and adjustable wrench 1406, illustrating progressive relative positions as the ratchet mechanism permits the nut 1404 to rotate in one direction only relative to the wrench. The clockwise direction of rotation of the wrench 1406 relative to the nut 1404 indicated by arrow 1402 forces rotation of the nut with the wrench. The ratchet mechanism does permits rotation of the nut relative to the wrench, when rotated as indicated by arrow 403, that is, when the wrench is rotated counterclockwise. Reversing the action from tightening to removing, simply involves reversing the wrench position from that as shown in FIG. 14a to that as shown in FIG. 15.

During the ratcheting action, is has been found that the nut can bind and fail to rotate. The jaw 1418 is preferable and provides with a smoothly curved edge 1414 at the point where the curvature of the jaw reverses and the jaw 1414 transitions to the reduced thickness region 1420. After passing over the curved region 1414, the apex 1422 of the nut 1404 rides along the ramp region 1420. The apex 1426, in this embodiment, encounters a curved region 1425 followed by a curved surface 1424. These curved or smooth transition surfaces negate the binding action encountered when an apex encounters a relatively sharp corner or transition region.

FIG. 15 is a schematic illustration of a further embodiment of an adjustable wrench, showing the wrench indicated generally as 15000 having a curved ramp region 1502 on the reduced thickness section 1506.

FIG. 16 is a schematic illustration of a still further embodiment of an adjustable wrench indicated generally as 1600 with curved transition region for smooth engagement with the apices of the nut 1602. The nut 1602 is seen to engage the ratchet elements 1604 and 1606.

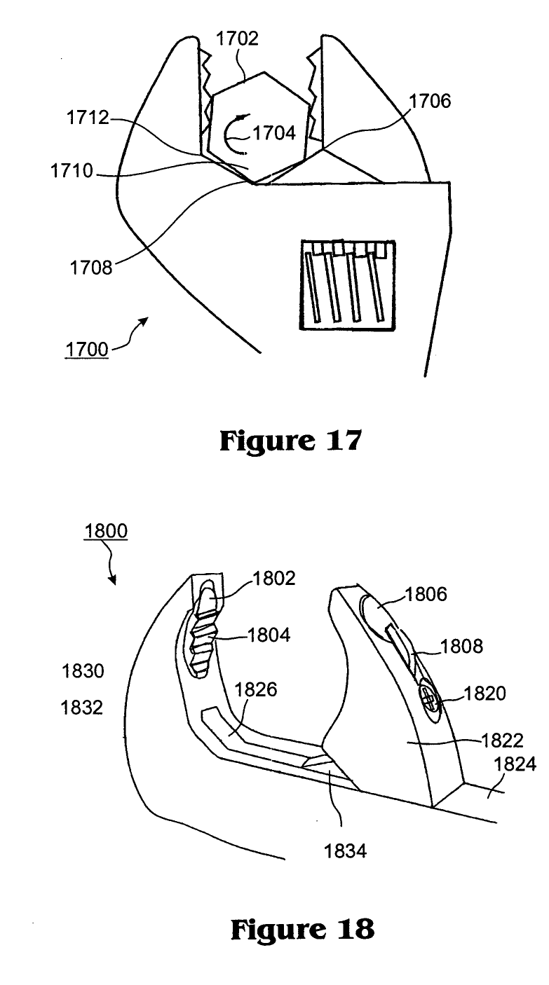

FIG. 17 is a schematic illustration of an adjustable wrench indicated generally as 1700, shown with a nut 1702 within the gripping jaws of the wrench and illustrates non-curved transition points 1712, 1708, and 1706.

FIG. 18 is a fragmentary perspective view of a still further alternate embodiment of a wrench indicated generally as 1800 and ratchet system of the present invention. The ratcheting mechanism includes the sliding toothed member 1830 having teeth 1804 and a flat region 1802. The flat region is at the distal end of the tooth member with the distal end being contained within the fixed jaw 1832. The opposing tooth member has its distal end 1806 retained by the retainer 1808. The retainer 1808 is in turn locked in position by the screw 1820. The screw 1820 is firmly secured to the movable jaw 1822. The movable jaw 1822 has a standard mechanism for movement along the surface 1824 of the wrench 1800. The groove 1826 receives the reduced thickness ramp member 1834.

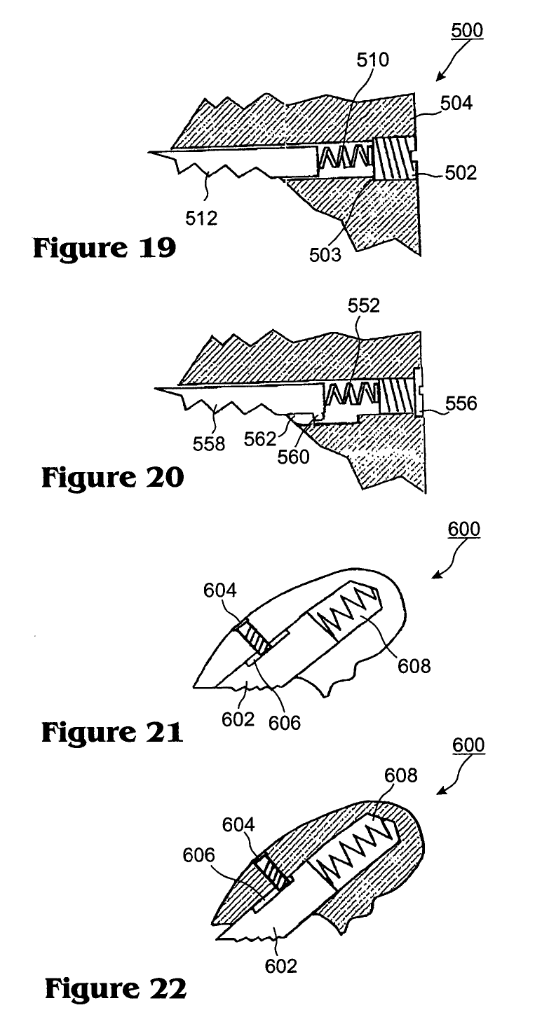

FIG. 19 is a fragmentary cross-sectional illustration of one embodiment of a seating mechanism for a screw portion of a ratchet mechanism indicated generally as 500. A screw member 502 is treated into the received hole 504 until the bottom of the screw seats firmly against the ledge 506. By over tightening of the screw 502 against the seat, the screw 502 can be securely locked in place such that i is not prone is working loose due to vibration or other actions. The screw 502, or set screw, is one example of the type of screws, or fastening, device that can be used. The ledge 506 is form by the decreased diameter of the circular passage 508, which is dimensioned to receive the spring 510 and retracting element 512. The spring 510 is wedged between the retracting element 512 and the screw 502, thereby permitting compression, or retraction, and returning the retracting element 512 to its resting position when not under pressure.

In FIG. 20, the wrench 550 uses a standard screw 556 to maintain the spring 552 within the retracting tunnel. To maintain the head of the screw 556 flush with the exterior of the wrench, the channel 554 is expanded at the point of entry to accommodate the screw head. By over tightening of the screw against the seat, the screw can be securely locked in place such that it is not prone is working loose due to vibration or other actions. In the embodiments illustrated in FIGS. 19 and 20, the retracting elements 512 and 558 have a channel 562 (illustrated in FIG. 20 only) within which the tooth 560 slides. The tooth 560, being part of the retracting element 512, prevents the element 512 from sliding out of the wrench 550 and 500 by contacting the wrench arc.

FIGS. 21 and 22 illustrate in more detail the sliding of the retracting element 602 within the tunnel 608. As can be seen in FIG. 22, when the retracting element 602 is in its resting position, the screw 604 is in contact with the end of the channel 606. However, as illustrated in FIG. 21, when the retracting element 602 is in the retracted position within the channel 608, the screw 604 is positioned closer to the opposing end of the channel 606.

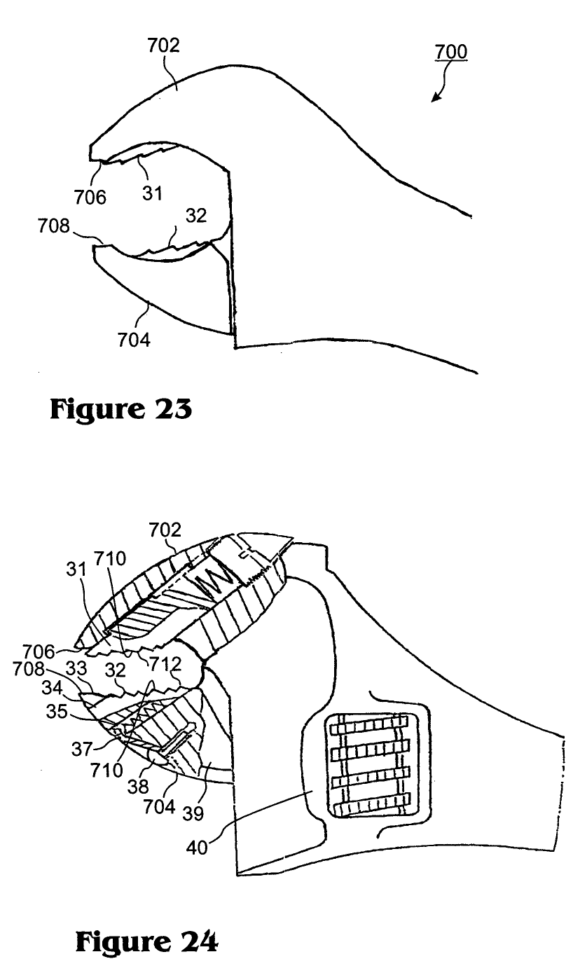

FIGS. 23 and 24 illustrate the principles of the present invention applied to an adjustable jaw wrench 700 with upper jaw 702 stationary relative to wrench 700, and lower jaw 704 gradually adjustable with threaded thumbwheel 40 either decreasing or increasing the width of the jaw. For purposes of this application, the width of the jaw is defined as the least linear distance between flat 706 of stationary jaw 702 and flat 708 of stationary jaw 704. Serrated ratcheting element 31 is mounted within the passage of stationary jaw 702, to expose a plurality of lands 710 separated by intermediate teeth 712 within the arc of the jaw, while the opposing ratcheting element 34 is mounted within a passage through the adjustable jaw 704, to reciprocate relative to the art of the wrench, with a plurality of land 710 separated by intermediate teeth 712 exposed by the passage through adjustable jaw 704, to the arc of the jaw. Flats 706, 708 are substantially parallel and tangents to teeth 712 of ratcheting elements 31, 32 are also substantially parallel, but those tangents are oblique to flats 706, 708. Ratcheting elements 31, 32 are held in their rest positions by respective springs, but reciprocate in opposite, longitudinal directions through their respective passages as wrench 700 is counter-turned in the ratcheting direction.

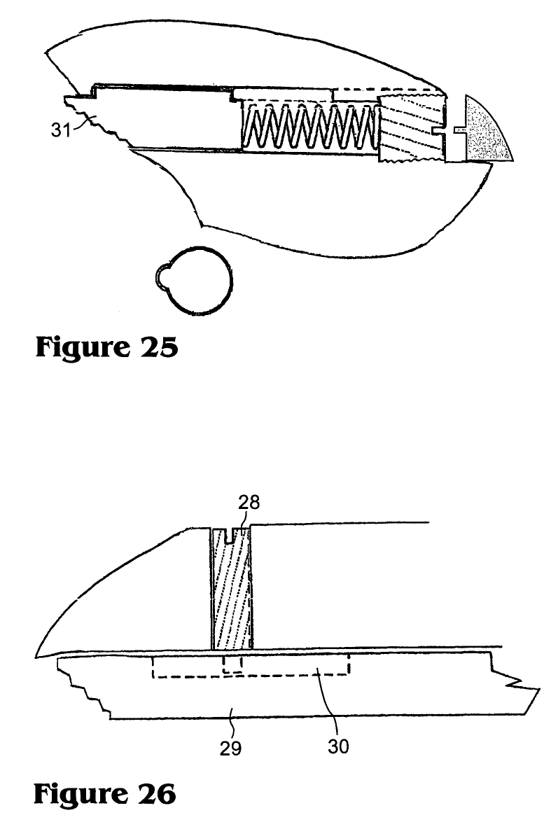

FIG. 25 illustrates an alternative arrangement of a channel in the jaw of a wrench accommodating the reciprocating motion of a ratcheting element 31, with the lands and teeth of ratcheting element 31 exposed to the arc of the jaw. A threaded element 720 closes the passage on the outside of the jaw, while compressing spring 721 against the proximal end of ratcheting element. An insert 722 covers thread fastener 720, to form a fresh surface on the outside of the jaw. A channel 726 runs partially along the length of passage 724, to accommodate a detent 728 that governs the extent of reciprocation element 31, as well as the degree of exposure of the lands and teeth of element 31.

FIG. 26 illustrates an alternative embodiment, with the detent held by the distal end of threaded member 28 extending into channel 30, thus controlling the degree of reciprocation of ratcheting element 31, as well as the degree of exposure of the lands and teeth of element 31.

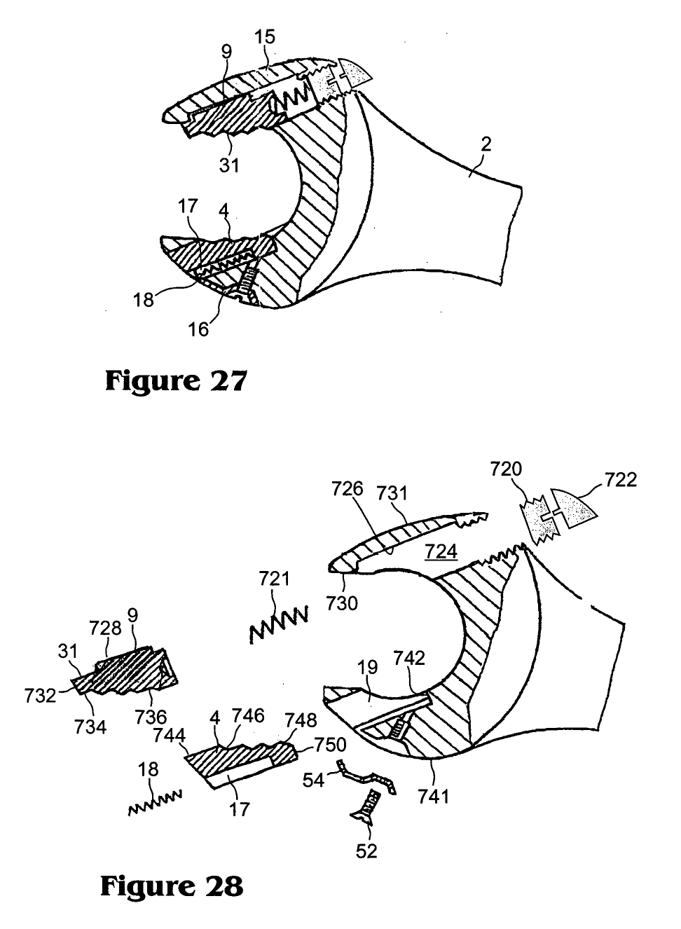

FIGS. 27 and 28 illustrate the application of the mounting of ratcheting element 31 shown in FIG. 25, to the upper jaw 15 of open end wrench 2. FIG. 28 illustrates the individual elements in an exploded view. Keeper 54 is held into threaded passage 60 by threaded fastener 52, to maintain spring 18 within channel 17, thereby maintaining ratcheting element 4 with a channel 19. It may be noted that channel 724 broaches the central portion of flats 730 of the upperjaw, and the distal terminal end 732 of ratcheting element 31 transversely intersects flat 730, and passage 724 terminates in the central portion of flat 730, with detent 9 abutting against the termination to limit the reciprocating action of element 31, and thus the degree to which element 31 extends into the arc.

Passage 19 on the a lower jaw 741 also broaches flat 740, and is terminated by a recess 742 into the arc subtended by lower jaw 741. The portion of arc subtended by upperjaw 731 is arcuately greater and the portion of the arc subtended by lower jaw 741.

The distal terminal end 732 of element 9 transversely intersect flat 730 and the most distal land 734 extends obliquely from terminal 3nd 732, spaced-apart from flat 730. In lower jaw 741, the proximal end 744 resides largely within passage 19, with the most proximal land 746 conforming to the coverture of that portion of the arc of the jaw subtended by lower jaw 741. The distal most land 748 extends transversely above the coverture of the arc, as the distal end 750 abuts the wall of recess 742.

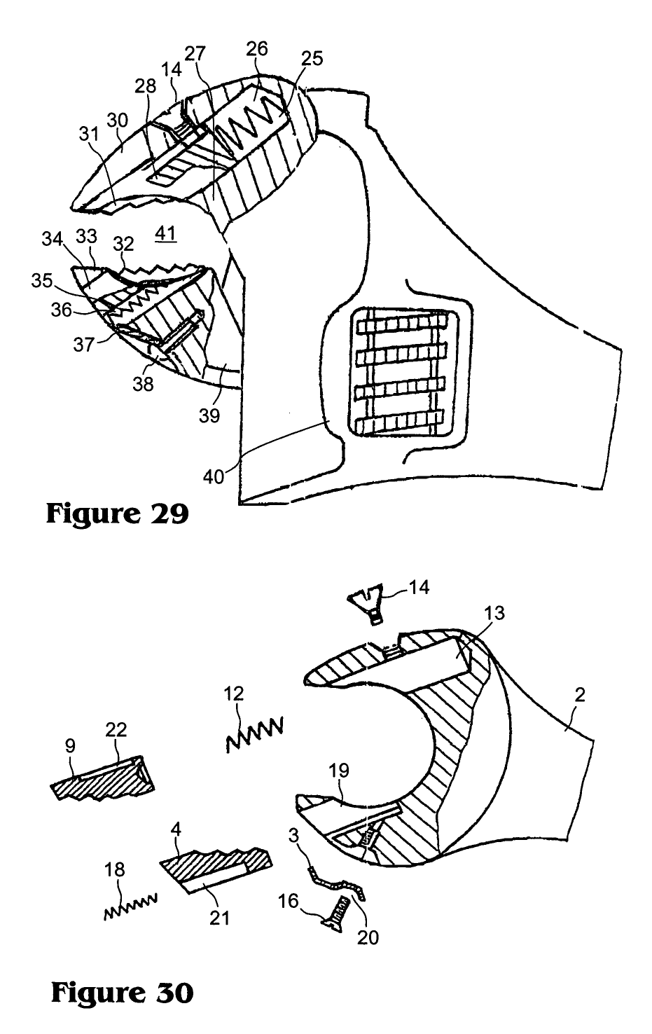

FIGS. 29 and 30 show comparable details of adjustable element installed respectively in an adjustable jaw wrench and an open end wrench. Flat screw 14 extends through a counter sunk passage 760, and thereby limits the protrusion of the distal end of screw 14 and to channel 22 of ratcheting element 9. This limitation upon the extended protrusion allows for an easy control of a single tolerance, namely the overall axial length of screw 14, and thereby enables quality control to prevent the distal end of screw 14 from binding upon the lower edge of channel 22, thus allowing ratcheting element 9 to freely reciprocate within passage 13.

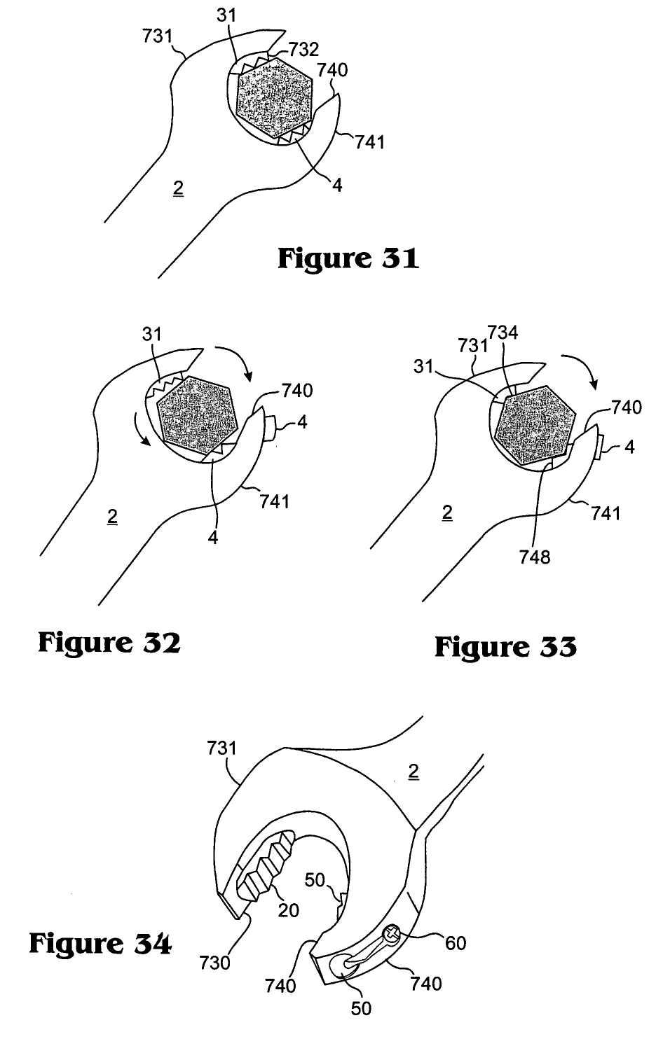

FIG. 31 illustrates the head of the hex bolt fully inside the arc formed between the two jaws of wrench 2, well inside the grasp of flat 730, with diametrically opposite lands of the hex head defining approximately parallel lines that are tangent to the teeth of elements 4, 31. The intermediate junction between the lands not tangent to the teeth of elements 4, 31 is held either in abutment against or nearly in abutment against the central portion of the arc, so as to wipe the wall of the arc whenever the arc is turned relative to the hex head bolt. In FIGS. 32 and 33, the junctions between the land of the hex head are similarly either abutting, or almost abutting the arc, so that the junctions in fact sweep against the arc as wrench to rotates relative to the hex head.

In the position shown in FIG. 31, wrench 2 might be either turned in a non-ratcheting orientation that will simultaneously rotate the hex head in a counter clockwise rotation to tighten the bolt, or counter-turned in with a clockwise rotation that will precipitate opposite longitudinal reciprocation of elements 4, 31 (assuming that both ratcheting elements 4, 31 are movably mounted in their respective jaws), relative to the lands of the hex head to assume the positions shown in FIG. 32, but will not rotate the hex head bolt as a result of this ratcheting movement.

When the rotation of wrench to is continued in a counter-clock wise direction to complete the transition between relative orientations of wrench 2 and the hex head illustrated by FIGS. 32 and 33, the hex head bolt remains in the same absolute orientation, while elements 4, 31 reciprocate in longitudinally opposite directions relative to the hex head bolt as well as relative to jaws 731, 741 in order to attain the orientation shown in FIG. 33. With these orientations, elements 4, 31, again hold the hex head in a grasp that equally allows wrench 2 to be freely turned either in a ratcheting motion relative to the hex head (which will not turn the hex head bolt) or in a non-ratcheting movement relative to hex head, that will simultaneously turn the hex head with the same degree of a rotation as wrench 2. As illustrated by comparison of FIGS. 31-33, there is a very fine degree of adjustment attainable between the equally ratcheting and non-ratcheting orientation of elements 4, 31 in FIGS. 31 and 33.

The foregoing paragraphs describe the details of a hand tool that may be constructed with one or more longitudinally reciprocating serrated inserts held by a pair of oppositely facing jaws forming an arc, with a first of the jaws defining an arcuate greater section of the arc and containing a first passage opening into the arc to expose a plurality of lands separated by intervening teeth of a movable ratcheting element, and a second of the jaws containing an arcuate lesser section of the arc and being perforated by a second passage opening into said arc to expose a plurality of lands separated by intervening teeth of an opposing ratcheting element, in a plurality of cooperating alignments with the lands and teeth of the movable element. The two ratcheting elements are disposed with the arc between the jaws to directly engage, in cooperation with individual lands of said opposing element, diametrically opposite features of a rotatable element, in a succession of grasps equally amenable to both non-ratchetable and ratchetable movement of said hand tool relative to the rotatable element.

While the present invention has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures maybe made from such details without departing from the spirit or scope of the applicant's general inventive concept.

What is claimed is:

1. A hand tool, comprising:
a pair of oppositely facing jaws forming an arc, with a first of said jaws containing an aperture opening into said arc;
a serrated movable element comprised of a proximal portion reciprocatingly received within said aperture and a distal portion exhibiting a plurality of lands separated by an array of intermediate teeth, borne within said arc by said first of said jaws; and
a serrated opposing element comprised of a plurality of lands separated by an array of intermediate teeth, borne by a second of said jaws within said arc, in facing opposition to said movable element, with individual lands of the distal end of the serrated, reciprocating element exposed to directly engage, in cooperation with the opposing element, diametrically opposite features of a rotatable element, in a succession of grasps equally amenable to both non-ratchetable and ratchetable movement of said hand tool relative to the rotatable element.

2. The hand tool of claim 1, comprised said second of said jaws bearing said opposing element in reciprocating longitudinal opposition to said movable element during said ratchetable movement.

3. The hand tool of claim 1, comprised of tangents to said intermediate teeth of said reciprocating element and said movable element being substantially parallel.

4. The hand tool of claim 1, comprised of said first of jaws and said second of said jaws each terminating opposite ends of said arc with a flat.

5. The hand tool of claim 1, comprised of:
said first of said jaws and said second of said jaws each terminating opposite ends of said arc with a flat; and
a terminal end of said movable element extending transversely from a central portion of a flat of said first of said jaws.

6. The hand tool of claim 1, comprised of:
said first of jaws and said second of said jaws each terminating opposite ends of said arc with a flat;
a terminal end of said movable element extending transversely from a central portion of a flat of said first of said jaws; and
a most distal one of said lands of said movable element extending from said terminal end of said movable element.

7. The hand tool of claim 1, comprised of:
said first of jaws and said second of said jaws each terminating opposite ends of said arc with a flat;
an intermediate section of said opposing element broaching a flat of said second of said jaws; and
a most proximal one of said lands of said opposing element extending from said flat of said second of said jaws.

8. The hand tool of claim 1, comprised of:
said first of jaws and said second of said jaws each terminating opposite ends of said arc with a flat;
a terminal end of said movable element extending transversely from a central portion of a flat of said first of said jaws;
a most distal one of said lands of said movable element extending from said terminal end of said movable element;
an intermediate section of said opposing element broaching a flat of said second of said jaws; and
a most proximal one of said lands of said opposing element extending from said flat of said second of said jaws.

9. The hand tool of claim 1, comprised of:
said first of said jaws and said second of said jaws each terminating opposite ends of said arc with a flat;
a terminal end of said movable element extending transversely from a central portion of a flat of said first of said jaws;
a most distal one of said lands of said movable element extending from said terminal end of said movable element;
an intermediate section of said opposing element broaching a flat of said second of said jaws; and
a most proximal one of said lands of said opposing element extending flush from said second of said jaws and conforming coextensively with said arc.

10. The hand tool of claim 1, comprised of:
an intermediate section of said movable element intersecting said arc; and
a most proximal one of said lands of said movable element extending flush from said first of said jaws and substantially conforming coextensively to curvature of said arc.

11. The hand tool of claim 1, comprised of:
said second of said jaws being perforated by a passage opening into said arc, with said passage terminating in a recess, formed in said arc; and
a terminal end of said opposing element butting against said recess, with a most distal one of said lands of said opposing element extending from said terminal end and transversely intersecting said arc.

12. The hand tool of claim 1, comprised of:
an intermediate section of said movable element broaching said arc;
a most proximal one of said lands of said movable element extending flush from said first of said jaws and substantially conforming coextensively to curvature of said arc;
said second of said jaws being perforated by a passage opening into said arc, with said passage terminating in a recess formed in said arc; and
a terminal end of said opposing element abutting against said recess, with a most distal one of said lands of said opposing element extending from said terminal end and transversely intersecting said arc.

13. The hand tool of claim 1, comprised of said second of said jaws being movably adjustable relative to said first of said jaws.

14. The hand tool of claim 1, comprised of said first of said jaws being movably adjustable relative to said second of said jaws.

15. The hand tool of claim 1, comprised of said aperture extending through said first of said jaws.

16. A hand tool, comprising:
a pair of oppositely facing jaws forming an arc, with a first of said jaws containing a first aperture opening into said arc and a second aperture extending transversely to said first opening from outside said arc and opening to said first aperture, said second aperture having a counterbored entry from said outside;
a serrated movable element bearing an open channel, comprised of a proximal portion reciprocatingly received within said first aperture with said open channel extending partially to a proximal terminus of said movable element and passing transversely to said second aperture, and a distal portion of said movable element exhibiting a plurality of lands separated by an array of intermediate teeth, borne within said arc by said first of said jaws; and
a serrated opposing element comprised of a plurality of lands separated by an array of intermediate teeth, borne by a second of said jaws, in facing opposition to said movable element, with individual lands of said movable element exposed to directly engage, in cooperation with the opposing element, diametrically opposite features of a rotatable element, in a plurality of equally non-ratchetable and ratchetable grasps.

17. The hand tool of claim 15, comprised of a fastener having a flanged portion mating against said counterbored entry and a distal end protruding beyond said second aperture and riding along said open channel as said movable element reciprocates within said first aperture.

18. A hand tool, comprising:
a pair of oppositely facing jaws forming an arc, with a first of said jaws defining an arcuate greater section of said arc and containing a first passage opening into said arc, and a second of said jaws containing an arcuate lesser section of said arc and being perforated by a second passage opening into said arc;
a movable element comprised of a proximal portion movably received within said first passage and a distal portion directed outwardly from said arc and exhibiting a plurality of lands separated by an array of intermediate teeth within said arc; and
an opposing element comprised of a proximal portion movably received within said second passage and a distal portion directed inwardly toward said arc to expose a plurality of lands separated by an array of intermediate teeth within said arc in facing opposition to said movable element, with said movable element and said opposing element respectively reciprocating relative to said first and second of said jaws in longitudinally opposite directions, with individual lands of said movable element exposed to directly engage, in cooperation with individual lands of said opposing element, diametrically opposite features of a rotatable element, in a succession of grasps equally amenable to both non-ratchetable and ratchetable movement of said hand tool relative to the rotatable element.

19. The hand tool of claim 20, comprised of a tangent to said teeth of said movable element being approximately parallel to a tangent to said teeth of said opposing element.
